(19) United States
(12) Patent Application Publication
(10) Pub. No.: US 2020/0265809 A1
(43) Pub. Date: Aug. 20, 2020

(54) USER INTERFACE DISPLAY METHOD

(71) Applicant: CAL-COMP BIG DATA, INC., New Taipei City (TW)

(72) Inventor: Chun-Lei Tsao, NEW TAIPEI CITY (TW)

(73) Assignee: CAL-COMP BIG DATA, INC., New Taipei City (TW)

(21) Appl. No.: 16/423,026

(22) Filed: May 26, 2019

(30) Foreign Application Priority Data
Feb. 18, 2019 (TW) 108105233

(51) Int. Cl. G09G 5/38; G06T 11/00; G06F 3/0484; G09B 19/00

(52) U.S. Cl. CPC G09G 5/38; G06T 11/001; G06F 3/04842; G09G 2340/0464; G06T 2200/24; G09G 2354/00; G09B 19/00

(57) ABSTRACT

A user interface display method is provided. The method includes: pre-storing, by a storage unit, a plurality of body type information arranged according to a rule; receiving, by an input unit, a physiological information of a user; and selecting, by a processing unit, a current body type information corresponding to the physiological information from the plurality of body information; selecting, by the processing unit, a plurality of first body type information similar to the current body type information from the body type information according to the rule; and displaying, by the display unit, the current body type information in a first position and respectively displaying the plurality of first body type information in a plurality of second positions, wherein the plurality of second positions are adjacent to the first position.

### CROSS-REFERENCE TO RELATED APPLICATION

This application claims the priority benefit of Taiwan application serial no. 108105233, filed on Feb. 18, 2019. The entirety of the above-mentioned patent application is hereby incorporated by reference herein and made a part of this specification.

### BACKGROUND

### Technical Field

The disclosure relates to a user interface display method, and particularly relates to a user interface display method used for displaying body types.

### Description of Related Art

In recent years, due to the popularity of fitness, the pursuit of a perfect body type has become a goal of many people. However, at present, there is no effective method or application to help users understand various possible body types, nor to help the users understanding how to advance from their current body type to a target body type. For example, the user does not know what his or her body type is, and the user does not know that in order to achieve the target body type, it is necessary to increase or decrease a fat mass, or increase or decrease a muscle mass.

### SUMMARY

The disclosure is directed to a user interface display method, which is adapted to display a current body type information of a user and a plurality of body type information similar to the current body type information, so that the user learns what his body type is in a graphical way.

The disclosure provides a user interface display method, which is adapted to an electronic device including a display unit, an input unit, a storage unit and a processing unit, the user interface display method includes: pre-storing a plurality of body type information arranged according to a rule by the storage unit; receiving a physiological information of a user by the input unit; and selecting a current body type information corresponding to the physiological information from the plurality of body type information by the processing unit; selecting a plurality of first body type information similar to the current body type information from the body type information by the processing unit according to the rule; and displaying the current body type information at a first position and respectively displaying the plurality of first body type information at a plurality of second positions by the display unit, wherein the plurality of second positions are adjacent to the first position.

In an embodiment of the disclosure, the step of pre-storing the plurality of body type information arranged according to the rule includes: sequentially arranging the plurality of body type information according to a muscle mass and a fat mass of each of the body type information by the processing unit, and sequentially storing the arranged body type information to an n*n first matrix, where n is a non-zero positive integer and n is an odd number.

In an embodiment of the disclosure, the current body type information is stored at an i^{th} row and a j^{th} column in the first matrix, wherein i is a non-zero positive integer smaller than or equal to n, and j is a non-zero positive integer smaller than or equal to n.

In an embodiment of the disclosure, the first body type information includes a second body type information stored at an (i−1)^{th} row and a (j−1)^{th} column in the first matrix, a third body type information stored at the (i−1)^{t1} row and the j^{th} column, a fourth body type information stored at the (i−1)^{th} row and a (j+1)^{th} column, a fifth body type information stored at the i^{th} row and the (j−1)^{th} column, a sixth body type information stored at the i^{th} row and the (j+1)^{th} column, a seventh body type information stored at an (i+1)^{th} row and the (j−1)^{th} column, an eighth body type information stored at the (i+1)^{th} row and the j^{th} column, and a ninth body type information stored at the (i+1)^{th} row and the (j+1)^{th} column.

In an embodiment of the disclosure, the step of displaying the current body type information at the first position and respectively displaying the plurality of first body type information at the plurality of second positions includes displaying the current body type information and the plurality of first body type information in an m*m second matrix by the display unit, wherein m is a non-zero positive integer and is m an odd number.

In an embodiment of the disclosure, the step of displaying the current body type information and the plurality of first body type information in the m*m second matrix includes displaying the current body type information at an x^{th} row and a y^{th} column in the second matrix by the display unit, displaying the second body type information at an (x−1)^{th} row and a (y−1)^{th} column in the second matrix, displaying the third body type information at the (x−1)^{th} row and the y^{th} column in the second matrix, displaying the fourth body type information at the (x−1)^{th} row and a (y+1)^{th} column in the second matrix, displaying the fifth body type information at the x^{th} row and the (y−1)^{th} column in the second matrix, displaying the sixth body type information at the x^{th} row and the (y+1)^{th} column in the second matrix, displaying the seventh body type information at an (x+1)′ row and the (y−1)^{th} column in the second matrix, displaying the eighth body type information at the (x+1)^{th} row and the y^{th} column in the second matrix, and displaying the ninth body type information at the (x+1)^{th} row and the (y+1)^{th} column in the second matrix, wherein x and y are respectively a quotient of (m+1)/2.

In an embodiment of the disclosure, each of the body type information includes an image, the image includes a human body, muscles of the human body are represented by a first color and fats of the human body are represented by a second color.

In an embodiment of the disclosure, before the step of displaying the current body type information at the first position and respectively displaying the plurality of first body type information at the plurality of second positions, the method further includes: displaying the current body type information and at least one body status value corresponding to the physiological information by the display unit.

In an embodiment of the disclosure, after the step of displaying the current body type information and the at least one body status value corresponding to the physiological information and before the step of displaying the current body type information at the first position and respectively displaying the plurality of first body type information at the plurality of second positions, the method further includes: receiving a selection operation corresponding to the current body type information by the input unit; and executing the step of displaying the current body type information at the first position and respectively displaying the plurality of first body type information at the plurality of second positions by the display unit according to the selection operation.

In an embodiment of the disclosure, the at least one body status value includes at least one of a body fat rate, a muscle mass, a body weight, a Body Mass Index (BMI), a basal metabolic rate, a visceral fat ratio, a water content and a bone weight.

Based on the above description, in the user interface display method of the disclosure, the user interface is adapted to display the current body type information of the user and the plurality of body type information similar to the current body type information, such that the user learns what his body type is in a graphical way.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram of an electronic device according to an embodiment of the disclosure.

FIG. 2A and FIG. 2B are schematic diagrams of body type information stored by the electronic device according to an embodiment of the disclosure.

FIG. 3 is a schematic diagram of images included in the body type information according to an embodiment of the disclosure.

FIG. 4 is a schematic diagram of displaying the body type information according to an embodiment of the disclosure.

FIG. 5 is a schematic diagram of displaying a current body type information and body status values according to an embodiment of the disclosure.

FIG. 6 is a flowchart illustrating a user interface display method according to an embodiment of the disclosure.

### DESCRIPTION OF THE EMBODIMENTS

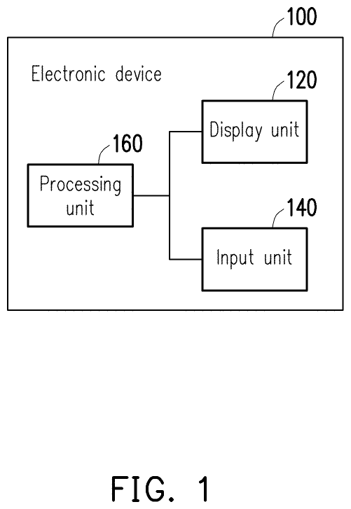

FIG. 1 is a block diagram of an electronic device according to an embodiment of the disclosure. Referring to FIG. 1, the electronic device 100 of the embodiment includes a display unit 120, an input unit 140 and a processing unit 160. The electronic device 100 is, for example, a mobile phone, a tablet computer, a notebook computer, etc., which is not limited by the disclosure.

The display unit 120 is adapted to provide a display function in a display area of the electronic device 100. The display unit 120 may be a display device adapted to provide the display function such as a Liquid Crystal Display (LCD), a Light-Emitting Diode (LED), a Field Emission Display (FED), etc.

The input unit 140 is, for example, an input device such as a mouse, a keyboard, a joystick or a touch panel, etc., which is capable of receiving an operation from a user. Moreover, the input unit 140 may also be a resistive, capacitive or other type of a touch sensing element, which may be integrated with the display unit 120 of the electronic device 100 to form a touch screen.

The processing unit 160 is respectively connected to the display unit 120 and the input unit 140, which may be a Central Processing Unit (CPU), or other programmable general purpose or special purpose microprocessor, a Digital Signal Processor (DSP), a programmable controller, an Application Specific Integrated Circuit (ASIC) or other similar device or a combination of the above devices.

In the exemplary embodiment, the electronic device 100 further includes a storage unit (not shown), the storage unit stores a plurality of program instructions, and after the program instructions are installed, the program instructions are executed by the processing unit 160. For example, the storage unit includes a plurality of modules, and operations of the electronic device 100 are respectively executed through the modules, where each of the modules is composed of one or a plurality of program instructions. However, the disclosure is not limited thereto, the operations of the electronic device 100 may also be implemented by using other hardware forms.

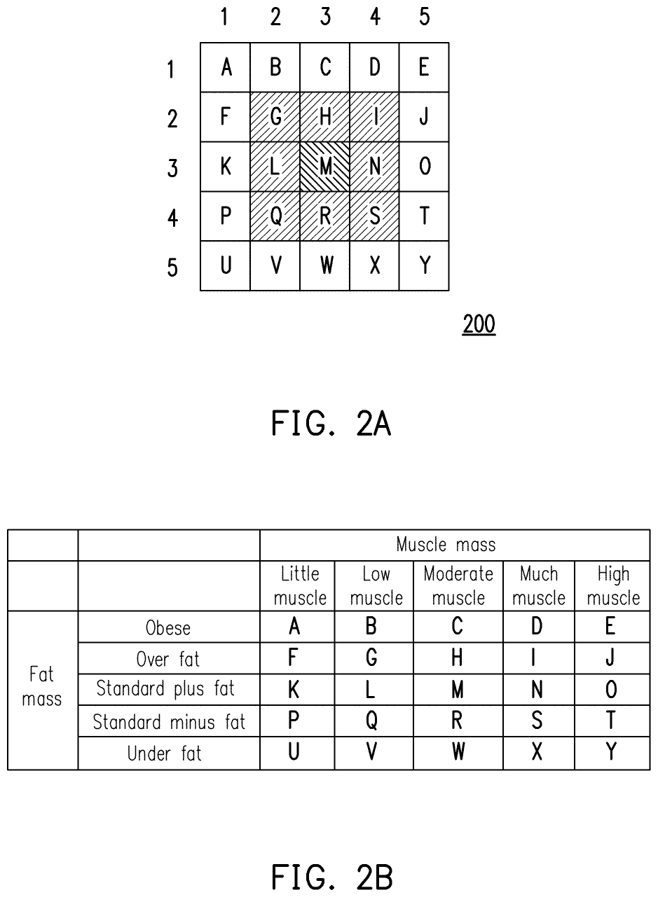

FIG. 2A and FIG. 2B are schematic diagrams of body type information stored by the electronic device according to an embodiment of the disclosure.

Referring to FIG. 2A and FIG. 2B, in FIG. 2A, it is assumed that the storage unit of the electronic device 100 may be pre-stored with 25 pieces of body type information (i.e. a body type information A to a body type information Y), where each of the body type information includes a muscle mass and a fat mass. The processing unit 160 sequentially arranges the body type information A to the body type information Y according to the muscle mass and the fat mass of each body type information, and sequentially stores the arranged body type information A to the body type information Y to a 5*5 matrix 200 (which is also referred to as a first matrix) as shown in FIG. 2A.

It is assumed that the fat mass is respectively into five grades of “obese”, “over fat”, “standard plus fat”, “standard minus fat” and “under fat” from a high fat mass to a low fat mass, and the muscle mass is respectively into five grades of “high muscle”, “much muscle”, “moderate muscle”, “low muscle” and “little muscle” from a high muscle mass to a low muscle mass.

Particularly, referring to both of the FIG. 2A and FIG. 2B, the fat mass of the body type information of a first row in the matrix 200 (i.e. the body type information A to the body type information E) is the “obese”. The fat mass of the body type information of a second row in the matrix 200 (i.e. the body type information F to the body type information J) is the “over fat”. The fat mass of the body type information of a third row in the matrix 200 (i.e. the body type information K to the body type information O) is the “standard plus fat”. The fat mass of the body type information of a fourth row in the matrix 200 (i.e. the body type information P to the body type information T) is the “standard minus fat”. The fat mass of the body type information of a fifth row in the matrix 200 (i.e. the body type information U to the body type information Y) is the “under fat”.

Moreover, the muscle mass of the body type information of a first column in the matrix 200 (i.e. the body type information A, F, K, P, U) is the “little muscle”. The muscle mass of the body type information of a second column in the matrix 200 (i.e. the body type information B, G, L, Q, V) is the “low muscle”. The muscle mass of the body type information of a third column in the matrix 200 (i.e. the body type information C, H, M, R, W) is the “moderate muscle”. The muscle mass of the body type information of a fourth column in the matrix 200 (i.e. the body type information D, I, N, S, X) is the “much muscle”. The muscle mass of the body type information of a fifth column in the matrix 200 (i.e. the body type information E, J, O, T, Y) is the “high muscle”.

Namely, the body type information A-Y are sorted according to the muscle mass and the fat mass, the 25 pieces of body type information may be sequentially stored in the 5*5 matrix 200 (which is also referred to as the first matrix), and each body type information may logically correspond to one element in the matrix 200. For example, the body type information A corresponds to an element located at a 1^{st} column and a 1^{st} row of the matrix 200; the body type information B corresponds to an element located at a 2^{nd} column and the 1^{st} row of the matrix 200; the body type information F corresponds to an element located at the 1^{st} column and a 2^{nd} row of the matrix 200, and the others are deduced by analogy. Particularly, the disclosure does not limit the number of pieces of the body type information and the size of the matrix 200, and in other exemplary embodiments, the electronic device 100 may store more or less body type information, and the size of the matrix 200 may be larger or smaller. In other embodiments, it is assumed that the size of the first matrix is n*n, and n is a non-zero positive integer and is an odd number.

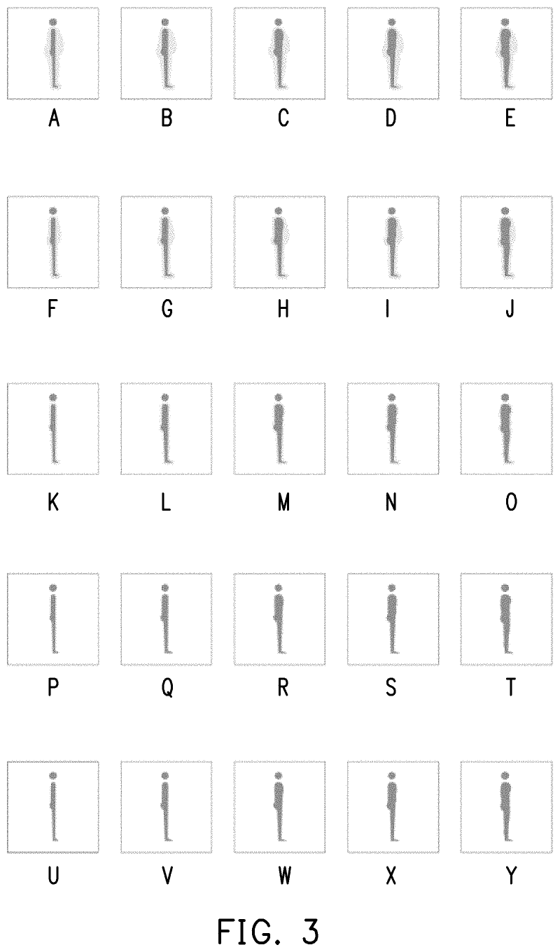

Particularly, FIG. 3 is a schematic diagram of images included in the body type information according to an embodiment of the disclosure. Referring to FIG. 3, in the embodiment, each one of the body type information A-Y further includes an image. The image includes a human body, and muscles of the human body are represented by a first color (for example, a red color) and fats of the human body are represented by a second color (for example, an orange color).

In the exemplary embodiment, the processing unit 160 may obtain a physiological information of the user, and select a body type information corresponding to the physiological information from the matrix 200 to serve as a current body type information of the user according to the physiological information of the user. For example, the user may input the physiological information of himself through the input unit 140, where the physiological information may be information such as height, weight, gender, age, etc. When the processing unit 160 receives the physiological information, the processing unit 160 may calculate a body fat rate (including the muscle mass and the fat mass) of the user according to the physiological information, and correspond the calculated body fat rate to one of the body type information A to the body type information Y. However, it should be noted that the above physiological information and the above method for obtaining the physiological information are not limited by the disclosure, and the method for corresponding the physiological information of the user to one of the plurality of body type information is also not limited by the disclosure.

It is assumed that the processing unit 160 sets the body type information M located at a 3^{rd} row and a 3^{rd} column of the matrix 200 as the current body type information of the user. The processing unit 160 may further select the body type information G (which is also referred to as a second body type information) located at the 2^{nd} row and the 2^{nd} column, the body type information H (which is also referred to as a third body type information) located at the 2^{nd} row and the 3^{rd} column, the body type information I (which is also referred to as a fourth body type information) located at the 2^{nd} row and a 4^{th} column, the body type information L (which is also referred to as a fifth body type information) located at the 3^{rd} row and the 2^{nd} column, the body type information N (which is also referred to as a sixth body type information) located at the 3^{rd} row and the 4^{th} column, the body type information Q (which is also referred to as a seventh body type information) located at the 4^{th} row and the 2^{nd} column, the body type information R (which is also referred to as an eighth body type information) located at the 4^{th} row and the 3^{rd} column and the body type information S (which is also referred to as a ninth body type information) located at the 4^{th} row and the 4^{th} column that are similar (or located adjacent to) to the body type information M according to an arranging rule of the matrix 200.

In other words, it is assumed that the current body type information is stored at the i^{th} row and the j^{th} column in the first matrix, the second body type information is then stored at the (i−1)^{th} row and the (j−1)^{th} column in the first matrix, the third body type information is stored at the (i−1)^{th} row and the j^{th} column in the first matrix, the fourth body type information is stored at the (i−1)^{th} row and the (j+1)^{th} column in the first matrix, the fifth body type information is stored at the i^{th} row and the (j−1)^{th} column in the first matrix, the sixth body type information is stored at the i^{th} row and the (j+1)^{th} column in the first matrix, the seventh body type information is stored at the (i+1)^{th} row and the (j−1)^{th} column in the first matrix, the eighth body type information is stored at the (i+1)^{th} row and the j^{th} column in the first matrix, and the ninth body type information is stored at the (i+1)^{th} row and the (j+1)^{th} column in the first matrix. In the exemplary embodiment, the second body type information, the third body type information, the fourth body type information, the fifth body type information, the sixth body type information, the seventh body type information, the eighth body type information and the ninth body type information may all be referred to as “first body type information”.

After the current body type information and the aforementioned plurality of first body type information are selected, the display unit of the electronic device 100 may display an image of the current body type information and an image of the first body type information.

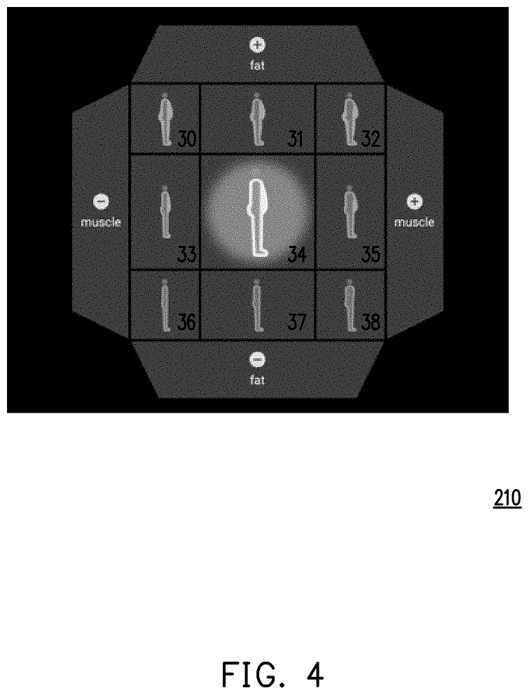

To be more specific, FIG. 4 is a schematic diagram of displaying the body type information according to an embodiment of the disclosure.

Referring to FIG. 4, the display unit 120 may display a user interface 210 with a 3*3 matrix (which is also referred to as a second matrix). The second matrix includes blocks 30-38. The block 30 is located at a 1^{st} row and a 1^{st} column in the second matrix. The block 31 is located at the 1^{st} row and a 2^{nd} column in the second matrix. The block 32 is located at a 1^{st} row and a 3^{rd} column in the second matrix. The block 33 is located at a 2^{nd} row and the 1^{st} column in the second matrix. The block 34 is located at the 2^{nd} row and the 2^{nd} column in the second matrix. The block 35 is located at the 2^{nd} row and the 3^{rd} column in the second matrix. The block 36 is located at a 3^{rd} row and the 1^{st} column in the second matrix. The block 37 is located at the 3^{rd} row and the 2^{nd} column in the second matrix. The block 38 is located at the 3^{rd} row and the 3^{rd} column in the second matrix.

After the current body type information and the aforementioned plurality of first body type information are selected, the display unit 120 may display the image of the body type information M in the block 34 of a first position (which is also referred to as a first block). Moreover, in the matrix 200, the body type information located around the body type information M may be respectively displayed in the blocks around the block 34 of the user interface 210.

To be specific, in the user interface 210, the image of the body type information G is displayed in the block 30 located to the upper left of the current body type information (i.e. the block 34); the image of the body type information H is displayed in the block 31 located on the top of the current body type information (i.e. the block 34); the image of the body type information I is displayed in the block 32 located to the upper right of the current body type information (i.e. the block 34); the image of the body type information L is displayed in the block 33 located to the left of the current body type information (i.e. the block 34); the image of the body type information N is displayed in the block 35 located to the right of the current body type information (i.e. the block 34); the image of the body type information Q is displayed in the block 36 located to the lower left of the current body type information (i.e. the block 34); the image of the body type information R is displayed in the block 37 located under the current body type information (i.e. the block 34); and the image of the body type information S is displayed in the block 38 located to the lower right of the current body type information (i.e. the block 34). Positions of the blocks 30-32, the block 33, the block 35 and the blocks 36-38 in the user interface 210 are all referred to as “second position”.

Namely, it is assumed that a magnitude of the second matrix displayed by the user interface 210 is m*m, where m is a non-zero positive integer and m is an odd number. The display unit 120 displays the current body type information at an x^{th} row and a y^{th} column in the second matrix, where x and y are respectively a quotient of (m+1)/2. Taking the aforementioned embodiment as an example, since m is 3, the image of the current body type information is displayed at the 2^{nd} row and the 2^{nd} column in the second matrix.

Moreover, the display unit 120 displays the aforementioned second body type information (i.e. the body type information G) at an (x−1)^{th} row and a (y−1)^{th} column in the second matrix, displays the third body type information (i.e. the body type information H) at the (x−1)^{th} row and the y^{th} column in the second matrix, displays the fourth body type information (i.e. the body type information I) at the (x−1)^{th} row and a (y+1)^{th} column in the second matrix, displays the fifth body type information (i.e. the body type information L) at the x^{th} row and the (y−1)^{th} column in the second matrix, displays the sixth body type information (i.e. the body type information N) at the x^{th} row and the (y+1)^{th} column in the second matrix, displays the seventh body type information (i.e. the body type information Q) at an (x+1)^{th} row and the (y−1)^{th} column in the second matrix, displays the eighth body type information (i.e. the body type information R) at the (x+1)^{th} row and the y^{th} column in the second matrix, and displays the ninth body type information (i.e. the body type information S) at the (x+1)^{th} row and the (y+1)^{th} column in the second matrix.

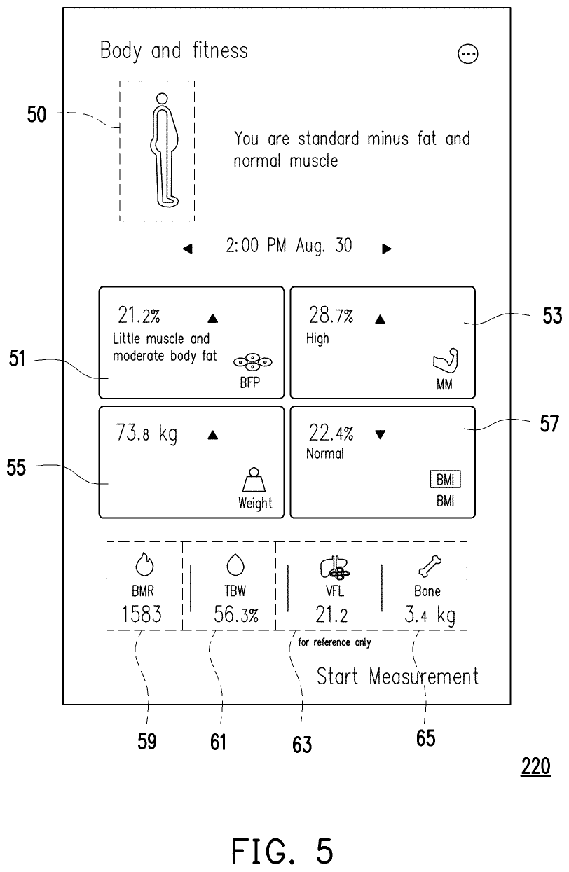

However, it should be noted that in other embodiments, before the aforementioned user interface 210 is displayed, the display unit 120 may further display the current body type information and at least one body status value corresponding to the physiological information of the user. For example, FIG. 5 is a schematic diagram of displaying the current body type information and body status values according to an embodiment of the disclosure.

Referring to FIG. 5, before the aforementioned user interface 210 is displayed, the display unit 120, for example, first displays a user interface 220. The user interface 220 includes an image 50 of the current body type information corresponding to the physiological information of the user and body status values corresponding to the physiological information. The body status values may include at least one of a body fat rate 51, a muscle mass 53, a body weight 55, a Body Mass Index (BMI) 57, a basal metabolic rate 59, a water content 61, a visceral fat ratio 63 and a bone weight 65.

Moreover, it is assumed that the user wants to switch the currently display user interface 220 to the user interface 210, the user may perform a selection operation (for example, to click and select) on the image 50 through the input unit 140, so that the electronic device 100 receives the selection operation corresponding to the current body type information. After the electronic device 100 receives the selection operation corresponding to the current body type information, the display unit 120 may execute the step of displaying the current body type information at the first position and respectively displaying the plurality of first body type information at the second positions according to the selection operation (i.e. display the user interface 210).

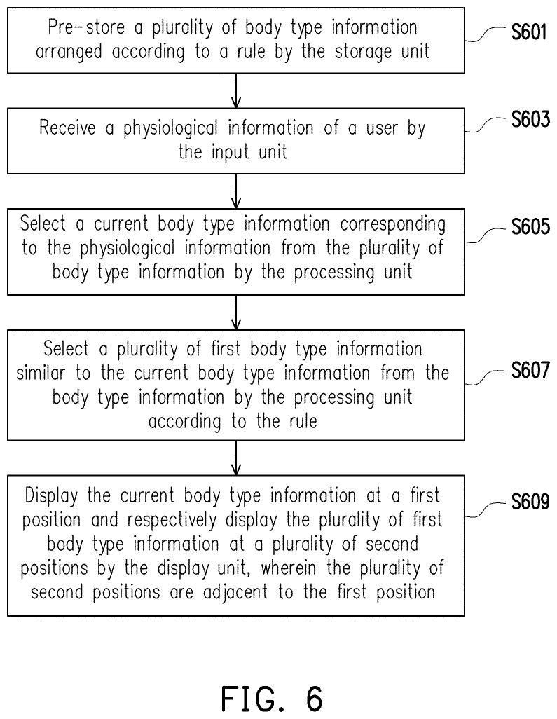

FIG. 6 is a flowchart illustrating a user interface display method according to an embodiment of the disclosure.

Referring to FIG. 6, in a step S601, the storage unit of the electronic device 100 pre-stores a plurality of body type information arranged according to a rule. In a step S603, the input unit 140 receives a physiological information of a user. In a step S605, the processing unit 160 selects a current body type information corresponding to the physiological information from the plurality of body type information. In a step S607, the processing unit 160 selects a plurality of first body type information similar to the current body type information from the body type information according to the rule. In a step S609, the display unit 140 displays the current body type information at a first position and respectively displays the plurality of first body type information at a plurality of second positions, where the plurality of second positions are adjacent to the first position.

In summary, in the user interface display method of the disclosure, the user interface is adapted to display the current body type information of the user and the plurality of body type information similar to the current body type information, such that the user learns what his body type is in a graphical way.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A user interface display method, adapted to an electronic device comprising a display unit, an input unit, a storage unit and a processing unit, the user interface display method comprising:
pre-storing a plurality of body type information arranged according to a rule by the storage unit;
receiving a physiological information of a user by the input unit;
selecting a current body type information corresponding to the physiological information from the plurality of body type information by the processing unit;
selecting a plurality of first body type information similar to the current body type information from the body type information by the processing unit according to the rule; and
displaying the current body type information at a first position and respectively displaying the plurality of first body type information at a plurality of second positions by the display unit, wherein the plurality of second positions are adjacent to the first position.

2. The user interface display method as claimed in claim 1, wherein the step of pre-storing the plurality of body type information arranged according to the rule comprises:
sequentially arranging the plurality of body type information according to a muscle mass and a fat mass of each of the body type information by the processing unit, and sequentially storing the arranged body type information to an n*n first matrix,
wherein n is a non-zero positive integer and n is an odd number.

3. The user interface display method as claimed in claim 2, wherein the current body type information is stored at an i^{th} row and a j^{th} column in the first matrix, wherein i is a non-zero positive integer smaller than or equal to n, and j is a non-zero positive integer smaller than or equal to n.

4. The user interface display method as claimed in claim 3, wherein the first body type information comprises a second body type information stored at an (i−1)^{t1} row and a (j−1)^{th} column in the first matrix, a third body type information stored at the (i−1)^{th} row and the j^{th} column, a fourth body type information stored at the (i−1)^{th} row and a (j+1)^{th} column, a fifth body type information stored at the i^{th} row and the (j−1)^{th} column, a sixth body type information stored at the i^{th} row and the (j+1)^{th} column, a seventh body type information stored at an (i+1)^{th} row and the (j−1)^{th} column, an eighth body type information stored at the (i+1)^{th} row and the j^{th} column, and a ninth body type information stored at the (i+1)^{th} row and the (j+1)^{th} column.

5. The user interface display method as claimed in claim 4, wherein the step of displaying the current body type information at the first position and respectively displaying the plurality of first body type information at the plurality of second positions comprises:
displaying the current body type information and the plurality of first body type information in an m*m second matrix by the display unit,
wherein m is a non-zero positive integer and m is an odd number.

6. The user interface display method as claimed in claim 5, wherein the step of displaying the current body type information and the plurality of first body type information in the m*m second matrix comprises:
displaying the current body type information at an x^{th} row and a y^{th} column in the second matrix by the display unit, displaying the second body type information at an (x−1)^{th} row and a (y−1)^{th} column in the second matrix, displaying the third body type information at the (x−1)^{th} row and the y^{th} column in the second matrix, displaying the fourth body type information at the (x−1)^{th} row and a (y+1)^{th} column in the second matrix, displaying the fifth body type information at the x^{th} row and the (y−1)^{th} column in the second matrix, displaying the sixth body type information at the x^{th} row and the (y+1)^{th} column in the second matrix, displaying the seventh body type information at an (x+1)^{th} row and the (y−1)^{th} column in the second matrix, displaying the eighth body type information at the (x+1)^{th} row and the y^{th} column in the second matrix, and displaying the ninth body type information at the (x+1)^{th} row and the (y+1)^{th} column in the second matrix,
wherein x and y are respectively a quotient of (m+1)/2.

7. The user interface display method as claimed in claim 1, wherein each of the body type information comprises an image, the image comprises a human body, muscles of the human body are represented by a first color and fats of the human body are represented by a second color.

8. The user interface display method as claimed in claim 1, wherein before the step of displaying the current body type information at the first position and respectively displaying the plurality of first body type information at the plurality of second positions, the user interface display method further comprises:
displaying the current body type information and at least one body status value corresponding to the physiological information by the display unit.

9. The user interface display method as claimed in claim 1, wherein after the step of displaying the current body type information and the at least one body status value corresponding to the physiological information and before the step of displaying the current body type information at the first position and respectively displaying the plurality of first body type information at the plurality of second positions, the user interface display method further comprises:
receiving a selection operation corresponding to the current body type information by the input unit; and
executing the step of displaying the current body type information at the first position and respectively displaying the plurality of first body type information at the plurality of second positions by the display unit according to the selection operation.

10. The user interface display method as claimed in claim 7, wherein the at least one body status value comprises at least one of a body fat rate, a muscle mass, a body weight, a Body Mass Index (BMI), a basal metabolic rate, a visceral fat ratio, a water content and a bone weight.
